(19) United States
(12) Patent Application Publication
(10) Pub. No.: US 2022/0074224 A1
(43) Pub. Date: Mar. 10, 2022

(54) Protective Canopy Barrier

(71) Applicant: Christina Licona, Owasso, OK (US)

(72) Inventor: Christina Licona, Owasso, OK (US)

(21) Appl. No.: 17/106,292

(22) Filed: Nov. 30, 2020

Related U.S. Application Data
(60) Provisional application No. 63/076,066, filed on Sep. 9, 2020.

(51) Int. Cl. E04H 15/00; E04H 15/34; A61G 13/00; A61G 13/10

(52) U.S. Cl. CPC E04H 15/008; A61G 13/10; A61G 13/009; E04H 15/34

(57) ABSTRACT

A protective canopy barrier for use with a procedure table used by massage therapist, an esthetician, a chiropractor, or a doctor. The protective canopy barrier is configured to at least partially enclose a client during a massage and protects both the client and massage therapist from transmitting or contracting pathogens, viruses, contaminants, etc. The protective canopy barrier comprises an adjustable frame that is attachable to the massage table. The frame is adjustable in height and may be configured to tilt at an angle to enclose different sized clients. The protective canopy device further comprises a draping cover configured to fit over the frame to partially encapsulate the massage table. The draping cover comprises a plurality of arm holes disposed therein providing access to the client while still providing a barrier. The draping cover further comprises a viewing door comprising a flap and a transparent window disposed therein allowing the massage therapist to view the client during the massage.

### CROSS-REFERENCE TO RELATED APPLICATION

The present application claims priority to, and the benefit of, U.S. Provisional Application No. 63/076,066, which was filed on Sep. 9, 2020, and is incorporated herein by reference in its entirety.

### FIELD OF THE INVENTION

The present invention relates generally to a new and improved massage table protective canopy barrier. More specifically, the invention relates to device that encloses a client during a massage or other treatment that protects both the client and massage therapist from transmitting or contracting pathogens, viruses, contaminants, etc. The device allows the massage therapist to easily access the client's body while maintaining an adequate level of protection between massage therapist and client. In addition, the device is adjustable in size to allow access to the body for various massage techniques. Accordingly, the present specification makes specific reference thereto. However, it is to be appreciated that aspects of the present invention are also equally amenable to other like applications, devices and methods of manufacture.

### BACKGROUND

In the age of COVID-19 personal protection devices such as face masks, gloves, and other personal protective equipment are often mandated to be worn in all business, including massage clinics and offices. However, this presents a problem to any patron of such an establishment whereby it may become uncomfortable for said patron to wear a face mask for a long period of time during a massage session especially in the prone position, or for any treatment of the face, such as, but not limited to facials, skin treatments, dental procedures, etc. As such, many clients prolong treatment to avoid this inconvenience, which in turn can amount to substantial business losses for massage establishment owners. As such, a suitable solution is required to prevent such losses for the reasons stated surrounding the possible transmission of viruses/pathogens/diseases and the requirements created by them.

Germs, viruses, bacteria, microbes, and other pathogens are tiny living things that are too small to be seen by the naked eye and exist throughout the world. These organisms are constantly present and persist on a wide variety of surfaces including clothing and human skin. A pathogen is a micro-organism that has the potential to cause disease. Inhaling these pathogens or introducing them into mucus membranes that exist in the eyes, nose, and mouth can lead to serious illness or even death. People carry these pathogens into homes and businesses unknowingly because they lack a proper means to sanitize or disinfect their persons before entering homes and businesses. This puts other occupants of the house or business at greater risk of infection as they interact with the person introducing the pathogens.

Healthcare workers are increasingly concerned about the incidence of transmission of communicable diseases from a patient to health care facility providers occurring during medical and therapeutic procedures. As a result, more attention is being given to the establishment and maintenance of protective devices usable during procedures and therapies. Despite these attentions, it can sometimes be difficult to remember to maintain and use these devices properly. As a result, communicable and infectious diseases may spread to the healthcare workers such as massage therapists or other therapists.

Protective drapes are sometimes used as a protective measure in the therapeutic fields. Protective drapes may be used to cover a patient during the performance of procedures and therapies and therefore, help prevent the possibility of infection or contaminants being transmitted from the patient to the therapist. Protective drapes provide protection to the therapy staff while taking care of a serious patient by creating and maintaining an effective barrier that minimizes the transmission of microorganisms between non-sterile and sterile areas. To perform adequately, the drapes should be made of a material that is resistant to blood, plasma, serums, and/or other bodily fluids to prohibit such fluids of a client from contaminating the germ-free field where the therapist is positioned. However, existing drapes are not usable for therapy procedures such as massages. Existing drapes are not adjustable or configured for uses that require significant unrestricted access to the body.

Therefore, there exists a long felt need in the art for an improved device that protects massage therapists and clients alike from transmitting/contracting airborne contaminants, diseases, pathogens, viruses, etc. in the age of a global pandemic. There also exists a long felt need in the art for a barrier that while adequately protecting a massage therapist and client, still allows the massage therapist to access the client's body in a relatively unrestricted manner. Finally, there is also a long felt need in the art for an improved massage table barrier that can be adjusted to fit and accommodate a plurality of client body sizes and massage positions via an adjustable and tiltable frame construction.

In this manner, the improved massage table barrier of the present invention accomplishes all of the forgoing objectives, by thereby protecting massage therapists and clients alike from transmitting/contracting airborne contaminants, diseases, pathogens, viruses, etc. The device also still allows the massage therapist to access the client's body in a relatively unrestricted manner while adequately protecting the massage therapist and client. Finally, the device can be adjusted to fit and accommodate a plurality of client body sizes and massage positions.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a protective canopy barrier for use with a treatment platform. The protective canopy barrier comprises a frame and a draping cover that is positional over the frame. The frame is adjustable and removable and attaches to the treatment platform, such as a massage table. The adjustable frame comprises a vertical frame component and a horizontal frame component attached via a pair of joints. The pair of joints may be fixed joints or articulating joints. The adjustable frame further comprises a pair of extension members. The pair of extension members allow the vertical frame component to adjust in height. During use, the draping cover rests on an upper member of the vertical frame component and the horizontal frame component and is also secured under a headrest area of the massage table to further secure the protective canopy barrier.

The draping cover is a typically a cloth of any type that completely encloses the client's upper body that provides enough protection to prevent the transmission of airborne droplets and may be a semi-transparent or translucent draping cover. The draping cover comprises a top surface, a front surface, a rear flap, and a pair of generally parallel side surfaces. The draping cover further comprises a protective skirting that extends downward from the front surface and attaches under a headrest of the table to encapsulate the client's head. The draping cover further comprises at least two arm holes to allow a massage therapist to access a client's body while keeping the protective canopy barrier in place over the client. In addition, the draping cover further comprises a viewing door comprising a transparent window covered by a flap attached to the front surface of the draping cover via a seam that allows a massage therapist to see into the protective canopy barrier and for a client to see out of the protective canopy barrier.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a protective canopy barrier of the present invention for use with a massage table in accordance with the disclosed architecture.

FIG. 2 illustrates a perspective view of a frame of the protective canopy barrier of the present invention attached to the massage table in accordance with disclosed architecture.

FIG. 3 illustrates a perspective view of an adjustable frame of the protective canopy barrier of the present invention attached to the massage table in accordance with disclosed architecture.

FIG. 4 illustrates a perspective view of a viewing door in a draping cover of the protective canopy barrier of the present invention for use with the massage table in accordance with disclosed architecture.

FIG. 5 illustrates a perspective view of an arm hole in the draping cover of the protective canopy barrier of the present invention for use with the massage table in accordance with disclosed architecture.

FIG. 6 illustrates a perspective view of a skirt of the draping cover of the protective canopy barrier of the present invention for use with the massage table in accordance with disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists in the art a long felt need for barrier device that protects clients and massage therapist alike from the transmission and contraction of virus, pathogens, diseases, contaminants, etc. during the course of a massage. There also exists a long felt need for such a device that accomplishes the desired protection level while still allowing a massage therapist to have functional access to the client's body to perform a massage. Further, there is a long felt need for such a device that expands/retracts/tilts in order to accommodate a wide variety of client body sizes and massage positions and allow the massage therapist easier access to the client.

The device of the present invention is designed to allow a massage therapist to access a client's body during a massage wherein both the massage therapist and client are both simultaneously protected from transmitting or contracting any pathogens, diseases, viruses, fluids, etc. from one another during the course of a massage. It can further be attached to any massage table via a construction and process that will be described more fully below.

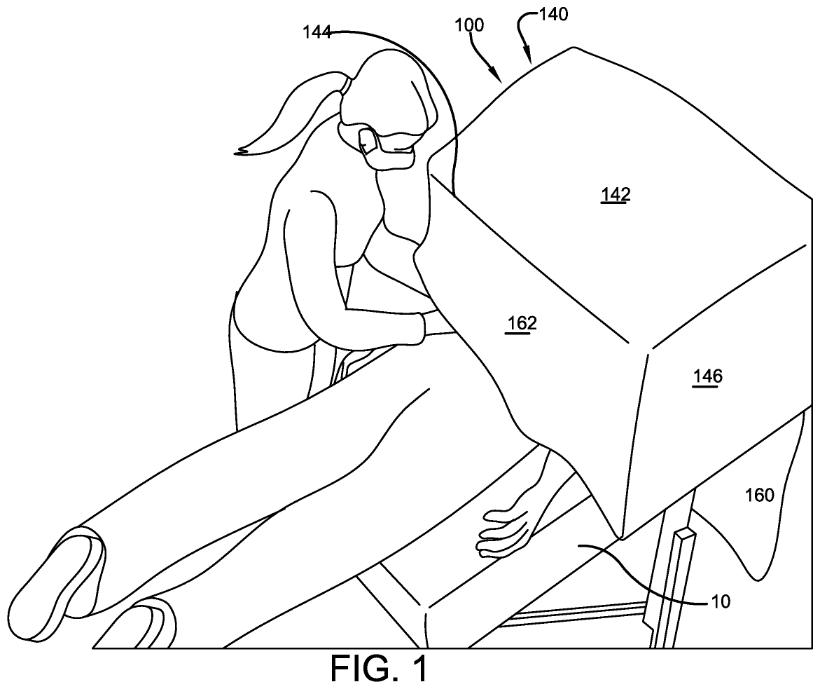

Referring initially to the drawings, FIG. 1 illustrates a perspective view of a protective canopy barrier 100. The protective canopy barrier 100 is configured for use with and is attachable to a treatment table 10. The treatment table 10 may be a massage table, a therapy table, a medical treatment table, a chiropractic treatment bed, or any other type of bed/table/platform that can support a person. The protective canopy barrier 100 comprises a frame 110 and a draping cover 140 that is positional over and drapes the frame 110.

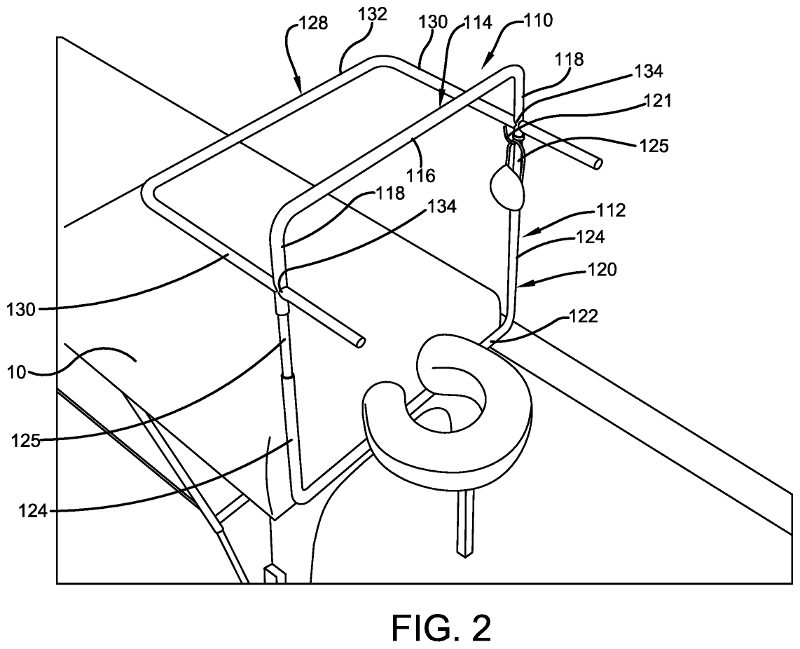

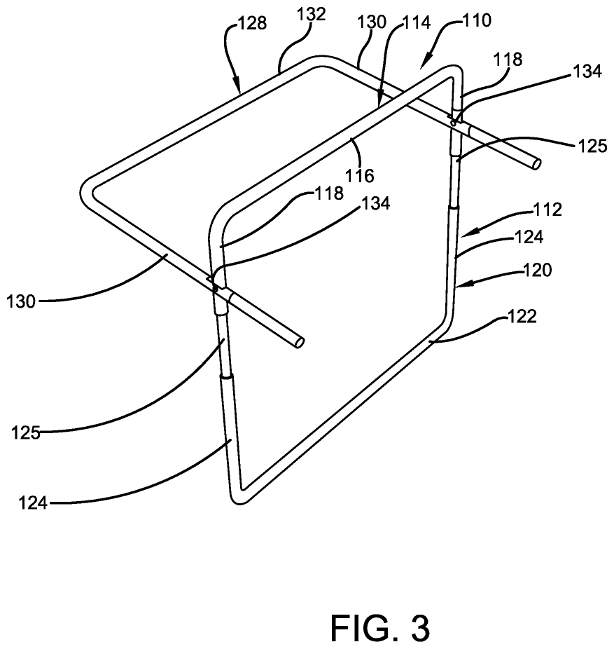

As illustrated in FIGS. 2 and 3, the frame 110 is adjustable and comprises a vertical frame component 112, a horizontal frame component 128, and a pair of extension members 125. All of the frame 110 components may be constructed from a plurality of differing materials such as, but not limited to, PVC, plastic, steel, aluminum, etc. The frame 110 components may be configured as a singular, hollow, tubular body with a generally rounded rectangular or square shape, although any shape or configuration as known in the art may be used.

The protective canopy barrier 100 may be secured to the treatment platform 10 by positioning the vertical frame component 112 underneath a headrest of the treatment platform 10. The vertical frame component 112 may be secured to the headrest or treatment platform 10 via a plurality of means such as, but not limited to, a plurality of integrated magnets (not shown), a clamping system (not shown), a set screw (not shown) wherein the screw travels through the frame 110 and into a surface of the treatment platform 10, a contoured portion of the frame 110 that engages the headrest or treatment platform 10 in a manner in which the protective canopy barrier's 100 own weight retains it to the treatment platform 10, and the like.

The vertical frame component 112 comprises an upper member 114 adjustably connected to a lower member 120 by the pair of extension members 125. The upper member 114 comprises a horizontal element 116 or cross member and a pair of vertical elements 118 extending downward therefrom. Similarly, the lower member 120 comprises a horizontal element 122 or cross member and a pair of vertical elements 124 extending upward therefrom and aligned to meet the pair of vertical elements 118 of the upper member 114. Each of the extension members 125 slidably engage one of the respective pairs of vertical elements 118 and 124 to adjust a height of the vertical frame component 112. The extension members 125 may be constructed of a solid piece of tubular material that is of the same construction as the frame 110 or may be semi-hollow or solid in construction. Hollow tubing and a diffuser may be used to deliver aroma therapy, steam, supplemental oxygen, etc., to the client within the canopy.

Additionally, the extension members 125 may engage the upper and lower members 114 and 120 via plurality of means such as, but not limited to, a grooved locking channel that is further comprised of a male member (not shown) of the extension members 125 that engages a female channel (not shown) or continuous opening (not shown) with one or both upper and lower members 114 and 120. Alternatively, a plurality of continuous openings (not shown) in the extension members 125 and the upper and lower members 114 and 120 and at least one pin securing means (not shown) that secures the extensions in a fixed position by being inserted through one or both upper and lower members 114 and 120 and through the respective extension member 125 (e.g. placing a series of pins through one or both upper and lower members 114 and 120 and through the extension member 125 which is within the upper and lower members 114 and 120 to lock all three members in a given position). Alternatively, a hydraulic piston system (not shown) that is powered by an electric motor (not shown) that raises/lowers the upper and lower members 114 and 120 via a remote control or mobile application controlled means via a smart device may be used.

The horizontal frame component 128 comprises a pair of parallel frame members 130 and a perpendicular cross member 132. The perpendicular cross member 132 connects the pair of parallel frame members 130 at one end. The frame 110 further comprises a pair of joints 134. The pair of joints 134 connect the horizontal frame component 128 to the pair of vertical elements 118 of the upper member 114 of the vertical frame component 112. The pair of joints 134 may be fixed joints as illustrated in FIG. 2. Alternatively, the pair of joints 134 may be articulating joints as illustrated in FIG. 3 allowing the horizontal frame component 128 to tilt with respect to the vertical frame component 112. The articulating joints may be a locking hinge pin, a ball and socket joint, a ratcheting gear mechanism, or a similar movable joint.

Differing embodiments of the protective canopy barrier 100 may allow the horizontal frame component 128 to attach to the vertical frame component 112 in a non-fixed means, such as a clip-on means that may comprised a generally c-shaped clamp that is fixedly attached to the vertical frame component 112 that engages the body of the horizontal frame component 128. Alternatively, the horizontal frame component 128 as a whole may be fixedly attached to the vertical frame component 112 wherein the horizontal frame component 128 is indistinguishable from the upper member 114 with a generally t-shaped intersection area (e.g. they are one unit/component in one molded piece). Furthermore, the horizontal frame component 128 may be comprised of at least two horizontal extensions (not shown) which allow the horizontal frame component 128 to be extended in the same manner as the pair of extension members 125 allow the vertical frame component 112. It is contemplated that said horizontal frame members may be constructed of the same types of extension mechanisms described for the pair of extension members 125 supra, as well as the same type of tilting mechanisms.

In addition, the vertical frame component 112, the horizontal frame component 128, or the pair of extension members 125 may integrate a hook 126 to secure a face mask of a user/client while within the protective canopy barrier 100. The hook 126 may be absent in favor of another securing component, such as, but not limited to, a pouch, a pocket, an enclosed vessel (e.g. box/compartment), etc. In addition, the frame 110 and all its components may be comprised of a means to hold or distribute a sanitizing agent onto the frame 110 itself or onto the massage table 10 below (e.g. a disinfecting mist sprayer). Further, all portions of the frame 110 may be magnetized or comprised of a magnetized material to engage the draping cover 140 in a process that will be more fully detailed below.

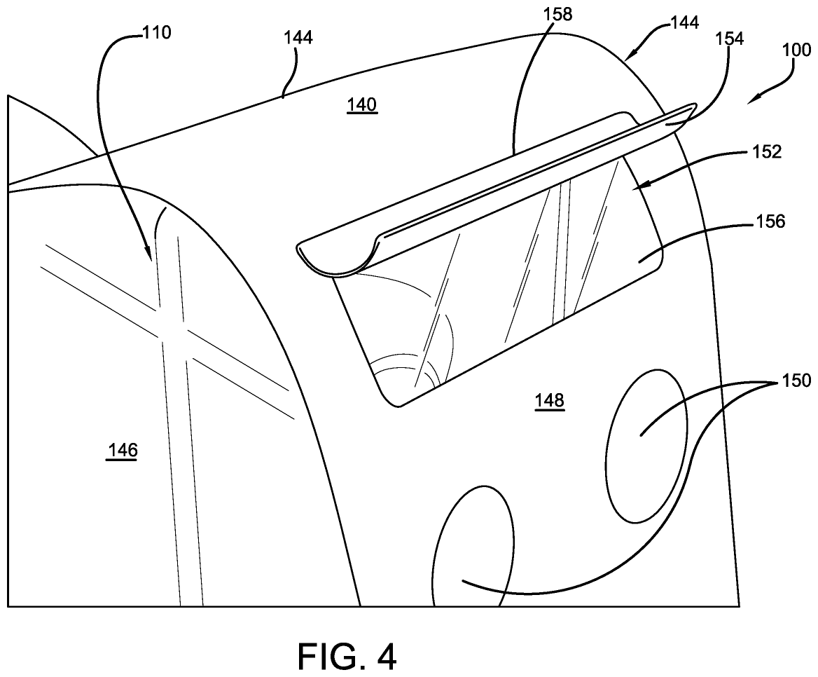

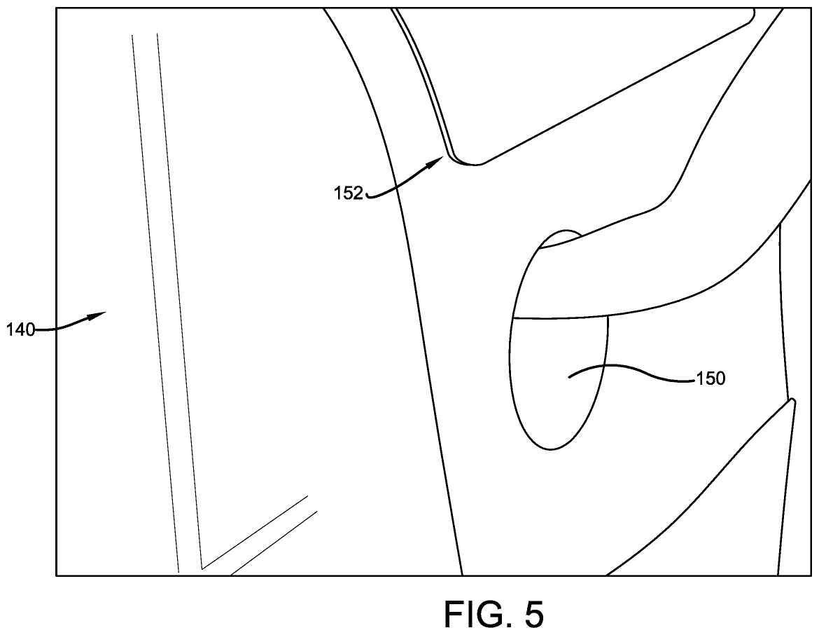

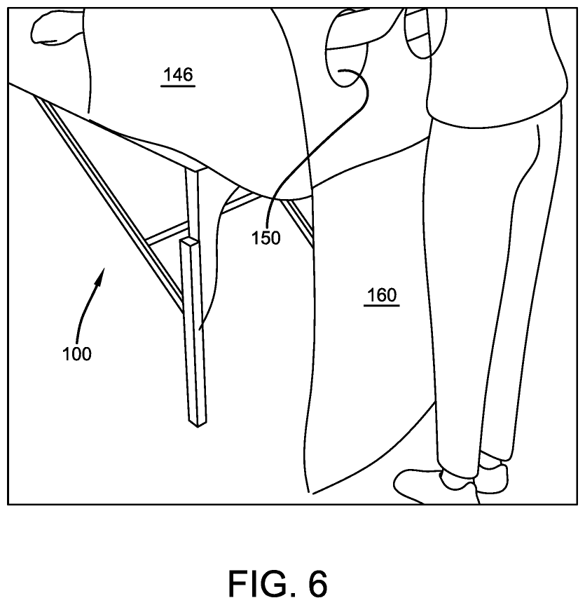

As illustrated in FIGS. 4-6, the draping cover 140 is comprised of a top surface 142, a pair of generally parallel and vertical extending side surfaces 146, a rear flap 162, and a front surface 148. The top surface 142 joins the rear flap 162 along a rear edge 144. The draping cover 140 is preferably constructed of a lightweight translucent or semi-transparent rigid or flexible material such as, but not limited to, glass, acrylic, plastic, etc. The draping cover 140 is positional over and rests on and is supported by the frame 110 to partially encapsulate the treatment platform 10. In differing embodiments, the draping cover 140 may be attached to the frame 110 via a plurality of fastening elements such as adhesives, screw/nut and bolt fastening combinations, magnets, a hook and loop material, etc.

The draping cover 140 further comprises a pair of arm holes 150. The pair of arm holes 150 are typically integrated into the front surface 148. The arm holes 150 allow a massage therapist to use their arms access the body of a client/user while still being protected from transmitting/contracting pathogens, viruses, diseases, etc. between the client and massage therapist. Alternatively, there may be additional arm holes (not shown) in the top surface 142, sides surfaces 146, and front surface 148 without limitation respective to positioning and number of openings. Further, the arm holes 150 may be beveled or contoured in differing embodiments to ensure a massage therapist's arms are not cut/damaged by an exposed plastic edge.

The draping cover 140 further comprises a viewing door 152. The viewing door 152 comprises a flap 154 and a transparent window 156 integrated into the draping cover 140 or onto the frame and attached by means of hook and loop fasteners or magnets. The flap 154 is attached to the draping cover 140 via a seam, integrated hinge, or living hinge 158. The flap 154 is closable to cover the window 156 for privacy. The viewing window 156 may be manufactured from vinyl, glass, or any other transparent material, and may be located within any portion/location of the front surface 148, side surfaces 146, and/or top surface 142 of the draping cover 140 without limitation regarding placement or number. The hinge 158 may be applied/molded to the draping cover 140 during the manufacturing process via an injection molded means, wherein the hinge 158 is comprised of the same material as the draping cover 140. In other embodiments, the hinge 158 may be comprised of a traditional hinge/locking hinge mechanism that is applied to the draping cover 140 after assembly, or no hinge mechanism at all. The flap 154 may further be rigid, semi-rigid, or flexible, and may be additionally comprised of a pull tab, handle, or other means to aid a user in opening the window 156.

Once pulled upward by a user, the flap 154 reveals the viewing window 156 which allows the client to look out from the draping cover 140 and also allows the massage therapist to look into the draping cover 140 at the client. Therefore, potential feelings of claustrophobia within the client and improved visibility for massaging the client's body for the massage therapist can be attained.

The draping cover 140 may further comprises a skirt 160. The skirt is attached to and extends generally downward from the front surface 148. The skirt 160 may be fixedly attached to the draping cover 140 or removable attached via a plurality of means such as, but not limited to, a plurality of integrated magnets (not shown), a clamping system (not shown), adhesive, screw/nut and bolt fastening means (not shown), a hook and loop material (not shown), a snap button means (not shown), and an integrated hinge/locking hinge that is comprised of the same material as the draping cover 140 or otherwise, etc. The skirt 160 further protects a lower body of the massage therapist from transmitting/contracting airborne contaminants/diseases/pathogens from or to the client. The skirt 160 is also used to come up under the headrest of the massage table when the client is in the prone position. When tucked in under the headrest, the skirt 160 further encapsulates the client to protect them from airborne pathogens. Alternatively, the skirt 160 may extend further around the pair of side surfaces 146.

The rear flap 162 may be constructed as a singular or a plurality of a plurality of slotted flaps (not shown), wherein each flap is comprised of a transparent, semi-transparent, or opaque material that may be rigid, semi-rigid, or flexible. The rear flap 162 is typically a transparent flexible vinyl material, but in differing embodiments the material may vary in composition. The rear flap 162 is ultimately fixed to the rear edge 144 of the top surface 142 which allows the rear flap 162 to swing/sway back and forth while still being retained to the draping cover 140. The rear flap 162 allows the massage therapist to insert their arms into the draping cover 140 to access the client's body.

Additionally, the rear flap 162 further protects both the massage therapist and client from transmitting or contracting any viruses, pathogens, diseases, etc. while still offering accessibility to the body of the client. In a differing embodiment, the rear flap 162 may be a fixed (e.g. non-movable, non-swaying) sheet/wall that may be transparent, semi-transparent, opaque, rigid, semi-rigid, or flexible wherein the rear flap 162 may employ a plurality of continuous arm holes (similar to 150) to allow the massage therapist to further access the client's body. In this embodiment, the rear flap 162 may further be anchored to the rear edge 144 of the top surface 142 as well as the side surfaces 146.

Notwithstanding the forgoing, the protective canopy barrier 100 can by any suitable size, shape, and configuration as is known in the art without affecting the overall concept of the invention, provided that it accomplishes the above stated objectives. One of ordinary skill in the art will appreciate that the shape and size of the protective canopy barrier 100 and its various components, as show in the FIGS. Are for illustrative purposes only, and that many other shapes and sizes of the protective canopy barrier 100 are well within the scope of the present disclosure. Although dimensions of the protective canopy barrier 100 and its components (i.e., length, width, and height) are important design parameters for good performance, the protective canopy barrier 100 and its various components may be any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective canopy barrier for use with a treatment platform comprising:
a frame; and
a draping cover positional over the frame; and
wherein the draping cover comprises a plurality of arm holes integrated into the draping cover.

2. The protective canopy barrier of claim 1, wherein the frame comprises a vertical frame component and horizontal frame component.

3. The protective canopy barrier of claim 1, wherein the frame is adjustably constructed.

4. The protective canopy barrier of claim 1, wherein the frame is attachable to the treatment platform.

5. The protective canopy barrier of claim 1, wherein the draping cover is configured to partially encapsulate the treatment platform.

6. The protective canopy barrier of claim 1, wherein the treatment platform is a massage table.

7. A protective canopy barrier for use with a treatment platform comprising:
an adjustable frame attachable to the treatment platform; and
a draping cover positional over the adjustable frame; and
wherein the draping cover comprises a plurality of arm holes and a viewing door integrated into the draping cover.

8. The protective canopy barrier of claim 7, wherein the viewing door comprises a flap and a window.

9. The protective canopy barrier of claim 8, wherein the flap is attached to the draping cover via a living hinge.

10. The protective canopy barrier of claim 7, wherein the draping cover is translucent.

11. The protective canopy barrier of claim 7, wherein the adjustable frame comprises a vertical frame component and horizontal frame component.

12. The protective canopy barrier of claim 11, wherein the vertical frame component comprises an upper member and a lower member.

13. The protective canopy barrier of claim 12, wherein the adjustable frame further comprises a pair of extension members adjustably connecting the upper member and the lower member.

14. The protective canopy barrier of claim 7, wherein the draping cover further comprises a skirt.

15. A protective canopy barrier for use with a massage table comprising:
an adjustable frame attachable to the massage table, the adjustable frame comprising a vertical frame component and a horizontal frame component attached via a pair of joints; and
a draping cover positional over the adjustable frame configured to partially encapsulate the massage table; and
wherein the draping cover comprises a plurality of arm holes and a viewing door comprising a flap and a window integrated into the draping cover.

16. The protective canopy barrier of claim 15, wherein the pair of joints are articulating joints.

17. The protective canopy barrier of claim 15, wherein the adjustable frame further comprises a pair of extension members for adjusting a height of the vertical frame component.

18. The protective canopy barrier of claim 15, wherein the draping cover is translucent, and the window is transparent.

19. The protective canopy barrier of claim 15, wherein the draping cover further comprises a skirt.

20. The protective canopy barrier of claim 15, wherein the horizontal frame component comprises a pair of parallel frame members connected by a perpendicular cross member.
